(19) United States
(12) Patent Application Publication
(10) Pub. No.: US 2012/0184764 A1
(43) Pub. Date: Jul. 19, 2012

(54) Process for preparing alkyl phosphates

(75) Inventor: Jan-Gerd Hansel, Bergisch Gladbach (DE)

(73) Assignee: LANXESS DEUTSCHLAND GMBH, Leverkusen (DE)

(21) Appl. No.: 13/349,858

(22) Filed: Jan. 13, 2012

(30) Foreign Application Priority Data
Jan. 17, 2011 (EP) 11151170.5

(51) Int. Cl. C07F 9/11

(52) U.S. Cl. 558/99

(57) ABSTRACT

The present invention relates to a process for preparing tetraalkyl bisphosphates by reacting tetrachlorobisphosphates with alcohols, neutralizing the resultant hydrogen chloride with a base, and isolating the salt formed in the neutralization from the reaction mixture as a solid.

The present invention relates to a process for preparing tetraalkyl bisphosphates by reacting tetrachlorobisphosphates with alcohols, neutralizing the resultant hydrogen chloride with a base, and isolating the salt formed in the neutralization from the reaction mixture as a solid.

Tetraalkyl bisphosphates are viscous liquids of low volatility and have been used for a long time for industrial applications, for example as polymer additives (see U.S. Pat. No. 2,782,128) or as hydraulic oils (see U.S. Pat. No. 4,056,480). For these applications it is typically necessary for the tetraalkyl bisphosphates to contain as few impurities as possible. Accordingly, the amount of acidic impurities, as may be determined, for example, by measuring the acid number, ought to be extremely low, since acid can lead to accelerated decomposition or corrosion. Tetraalkyl bisphosphates with an acid number of greater than about 1.0 mg KOH/g are unusable for the cited applications. Similarly to acids, impurities with bases are unwanted as well, since in the application they may act unwantedly as catalysts. Moreover, the presence of electrolytes is undesirable, since it may likewise cause corrosion problems or may lead to an incompatibility between tetraalkyl bisphosphate and a polymer matrix. Levels of metal ions of greater than about 5000 ppm, as may be determined by means of known chromatographic or spectroscopic methods, are undesirable.

Various processes for preparing tetraalkyl bisphosphates are known. However, they have deficiencies, in that the prevention or removal of the aforementioned impurities is costly and inconvenient, and so are unsuitable for industrial production. Furthermore, the known processes afford unsatisfactory yields, hence necessitating a technically costly and inconvenient removal and disposal of unused raw materials or of by-products.

U.S. Pat. No. 2,782,128 describes a process for preparing tetraalkyl bisphosphates by reaction of dialkyl chlorophosphates with diols in the presence of pyridine. The dialkyl chlorophosphate intermediate prepared in the first stage of the synthesis sequence from phosphorus trichloride, alcohol and chlorine has to be worked up with the benzene solvent and then distilled under reduced pressure. In the second stage, the by-product pyridine hydrochloride has to be precipitated by addition of diethyl ether solvent. Furthermore, residues of the pyridine have to be extracted using hydrochloric acid, and the product phase then has to be washed in with sodium hydroxide solution until acid-free, and washed with water until neutral. Finally, the distillative removal of the solvent and of residues of water is necessary. The overall yield over both stages is said to be 74%-77%. Disadvantages of this process are the large number of work-up operations required, the multiple use of solvents, and the merely moderate yield.

The publication “Diphosphate Ester Plasticizers” in Indust. Eng. Chem. 1950, Volume 42, p. 488, describes a similar process to U.S. Pat. No. 2,782,128, and cites disadvantages of this process as being that the yield, at only 50%, is very low and that there are considerable difficulties in connection with the purification of the intermediates and of the end product. An alternative described is a better process, in which a diol is reacted in a first stage with phosphorus oxychloride to form a tetrachlorobisphosphate, which then, in the second stage, reacts with the alcohol to form the end product. Though the yields are said to be satisfactory, they are not in fact quoted. To work up the reaction mixture from the second stage, pyridine is added, the precipitated pyridine hydrochloride is filtered off with suction, and the product phase is then washed with water. Lastly, pyridine residues have to be removed under reduced pressure.

A disadvantage of this procedure to start with is the difficulty in removing the pyridine residues fully from the end product. Removing the pyridine hydrochloride satisfactorily from the tetraalkyl bisphosphate by filtration is achieved only when its solubility in tetraalkyl bisphosphate is low. A further disadvantage arises from the fact that the product phase is washed with water. If the tetraalkyl bisphosphate is partly miscible with water, then losses of yield in the course of this operation are unavoidable. In the case of tetraalkyl bisphosphates which are miscible with water in any proportion, this washing fails completely, since it is impossible to separate the product from the waste water by phase separation.

U.S. Pat. No. 4,056,480 proposes a similar process for preparing tetraalkyl bisphosphates, in which, again, a diol is reacted in the first stage with phosphorous oxychloride to form a tetrachlorobisphosphate, which in the second stage reacts with the alcohol to form the end product. In the isolation of the end product, instead of pyridine, a dilute sodium hydroxide solution is used. A mixture is formed from which the liquid product phase can be isolated by phase separation. When the excess alcohol has been removed from the product phase by distillation, the product must be washed once again with water and finally freed from residues of water under reduced pressure. The yields of tetraalkyl bisphosphates are 12%-74%.

Disadvantages of this process are, again, the merely moderate yield and the fact that the process involves a number of liquid-liquid phase separations. Consequently, the process is poorly suited to the preparation of partly water-soluble tetraalkyl bisphosphates, and entirely unsuited to the preparation of fully water-soluble tetraalkyl bisphosphates.

It is an object of the present invention to provide a process for preparing tetraalkyl bisphosphates that is easier to carry out and affords better yields than in the prior art and is also suitable for preparing fully or partly water-soluble tetraalkyl bisphosphates.

Surprisingly it has been found that tetraalkyl bisphosphates can be prepared easily and in good yield if the hydrogen chloride formed in the reaction of tetrachlorobisphosphates with alcohols is neutralized with a base and the salt formed in the neutralization is isolated as a solid from the reaction mixture. The stated object is thus achieved by means of a process for preparing tetraalkyl bisphosphates, characterized in that
a) a tetrachlorobisphosphate is reacted with one or more alcohols,
b) when in step a) at least 50% of the P—Cl groups present in the tetrachlorobisphosphate have reacted, the reaction mixture from step a) is reacted with a base comprising one or more substances of the formula (Catⁿ⁺)ₐ(X^{m-})_{b}, in which Catⁿ⁺ is a cation with a charge of n, X^{m-} is an anion with a charge of m, and a and b are integers which satisfy the condition n×a=m×b,
c) at least part of the salt CatClₙ formed in step b) is precipitated as a solid, and
d) the solid CatClₙ is isolated from the mixture obtained in step c).

Preferably in formula (Catⁿ⁺)ₐ(X^{m-})₆
n represents 1, 2 or 3
m represents 1, 2 or 3
a represents 1, 2 or 3
and
b represents 1, 2 or 3

In one preferred embodiment, the base in step b) consists of one or more substances of the formula (Catⁿ⁺)ₐ(X^{m-})_{b}. The term “tetraalkyl bisphosphates” identifies organic substances which contain per molecule two phosphoric ester groups —O—P(═O)(OR)₂, where R stands generally for alkyl radicals, and the alkyl radicals R present in a molecule may be identical or different. The term “fully or partly water-soluble” in connection with the present invention identifies substances whose solubility in water at 25° C. is greater than about 1 percent by weight. The term “tetrachlorobisphosphates” identifies organic substances which contain per molecule two phosphoric ester dichloride groups —O—P(═O)Cl₂.

The tetrachlorobisphosphates used in the process of the invention can be prepared by known methods, as are described, for example, in Indust. Eng. Chem. 1950, Volume 42, p. 488 or in U.S. Pat. No. 4,056,480.

The tetrachlorobisphosphates used in the process of the invention correspond preferably to the general formula (I)

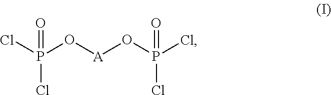

in which
A is a straight-chain, branched and/or cyclic C₄ to C₂₀ alkylene radical, a moiety —CH₂—CH═CH—CH₂—, a moiety —CH₂—C≡C—CH₂—, a moiety —CHR⁵—CHR⁶—(O—CHR⁷—CHR⁸)ₐ—, in which a is a number from 1 to 5, a moiety —CHR⁵—CHR⁶—S(O)_{b}—CHR⁷—CHR⁸—, in which b is a number from 0 to 2, or a moiety —(CHR⁵—CHR⁶)_{c}—O—R⁹—O—(CHR⁷—CHR⁸)_{d}—, in which c and d independently of one another are numbers from 1 to 5,
R⁵, R⁶, R⁷, R⁸ independently of one another are H or methyl,
R⁹ is a moiety —CH₂—CH═CH—CH₂—, a moiety —CH₂—C≡C—CH₂—, a 1,2-phenylene radical, a 1,3-phenylene radical, a 1,4-phenylene radical, a radical of the general formula (II),

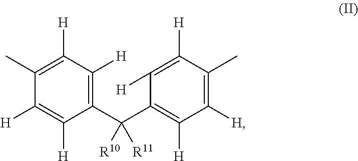

a radical of the general formula (III),

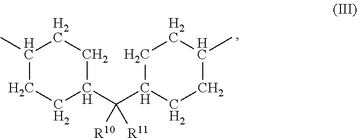

a radical of the general formula (IV),

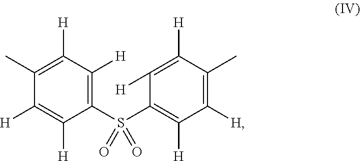

or a radical of the formula —C(═O)—R¹²—C(═O)—,
R¹⁰ and R¹¹ independently of one another are H or C₁ to C₄ alkyl, or R¹⁰ and R¹¹ together form an optionally alkyl-substituted ring having 4 to 8 C atoms, and
R¹² is a straight-chain, branched and/or cyclic C₂ to C₈ alkylene radical, a 1,2-phenylene radical, a 1,3-phenylene radical, or a 1,4-phenylene radical.

Preferably A is a straight-chain C₄ to C₆ alkylene radical or preferably A is a moiety of the general formula (III) in which R¹⁰ and R¹¹ are identical and are methyl, a moiety of the formula (V), (VI) or (VII),

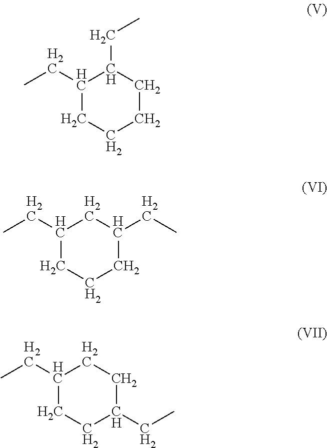

or preferably A is a moiety —CHR⁵—CHR⁶—(O—CHR⁷—CHR⁸)ₐ—, in which a is a number from 1 to 2 and R⁵, R⁶, R⁷ and R⁸ are identical and are H or preferably A is a moiety —(CHR⁵—CHR⁶)_{c}—O—R⁹—O—(CHR⁷—CHR⁸)_{d}—, in which c and d independently of one another are a number from 1 to 2, R⁹ is a moiety of the general formula (II) and R¹⁰ and R¹¹ are identical and are methyl.

With particular preference A is a radical selected from the group consisting of —CH₂CH₂—O—CH₂CH₂—, —CH₂CH₂CH₂CH₂— and —CH₂—CH(CH₂CH₂)₂CH—CH₂—.

The alcohols used in the process of the invention are preferably selected from the group consisting of methanol, ethanol, 1-propanol, 2-propanol, 2-methyl-1-propanol, 1-butanol and 2-butanol. It is particularly preferred to use methanol and ethanol.

The bases of the formula (Catⁿ⁺)ₐ(X^{m-})_{b} used in the process of the invention are preferably ammonium salts, alkali metal salts or alkaline earth metal salts. The anion these salts comprise is preferably hydroxide, alkoxide, oxide, carbonate, hydrogencarbonate, phosphate, hydrogenphosphate, dihydrogenphosphate or acetate. Particular preference is given to ammonium hydroxide, lithium hydroxide, sodium hydroxide, sodium methoxide, sodium ethoxide, sodium carbonate, sodium hydrogencarbonate, trisodium phosphate, disodium hydrogenphosphate, sodium acetate, potassium hydroxide, potassium tert-butoxide, potassium carbonate, potassium hydrogencarbonate, caesium hydroxide, magnesium hydroxide, magnesium oxide, calcium hydroxide, calcium methoxide or calcium oxide. Employed with more particular preference are sodium hydroxide, sodium carbonate, sodium hydrogencarbonate, potassium hydroxide, potassium carbonate or potassium hydrogencarbonate.

Step a) of the process of the invention is carried out using at least four mole equivalents of alcohol per mole equivalent of tetrachlorobisphosphate. The reactants can be reacted with one another in bulk or in solution in a solvent. Suitable solvents are toluene, heptane and dichloromethane, and also an excess of the alcohol used in the reaction. The tetrachlorobisphosphate is introduced into a reaction vessel and the alcohol is metered in. Alternatively, the alcohol is introduced into a reaction vessel and the tetrachlorobisphosphate is metered in. It is also possible for alcohol and tetrachlorobisphosphate to be metered in parallel into a reaction vessel. In place of the pure reactants, solutions of the reactants can also be metered.

In the reaction which then proceeds, the P—Cl groups of the tetrachlorobisphosphate are converted, by reaction with the alcohol, into P—OR groups, and hydrogen chloride is liberated.

The reaction is carried out preferably at temperatures between −10° C. and +70° C. and under pressures between 10 and 6000 mbar. The reactants are contacted with one another in this procedure by means of suitable measures, more particularly by stirring.

By-product hydrogen chloride formed in the reaction is preferably left substantially in the reaction mixture and neutralized with the base in step b) of the process. In an alternative, likewise preferred embodiment of the process, the hydrogen chloride formed as a by-product is removed in circulation at least partly from the reaction vessel. This is done, for example, by application of a vacuum or by the passing of an inert gas such as nitrogen or carbon dioxide through the reaction vessel.

In one alternative embodiment, step a) may involve further, optional separative operations, preferably a distillation to remove unreacted alcohol, for example.

The subsequent step b) is carried out only when at least 50% of the P—Cl groups present in the tetrachlorobisphosphate have been reacted in step a). The conversion of the P—Cl groups can be monitored analytically, preferably by means of ³¹P-NMR spectroscopy.

For the implementation of step b), the base, preferably in an amount of 3.5 to 8 mole equivalents per mole equivalent of tetrachlorobisphosphate, is contacted with the reaction mixture obtained in step a), with thorough mixing.

The base is preferably introduced in a meterable form into the reaction vessel of step a). Alternatively and likewise preferably, the base in a suitable form is introduced into a second reaction vessel, and the reaction mixture from step a) is transferred to this vessel.

Suitable and preferred meterable forms of the base are powders, granules, solutions or dispersions. One particularly preferred embodiment of the process uses the base in the form of an aqueous solution or dispersion. Very particular preference is given to using a 10%-60% strength by weight aqueous solution of sodium hydroxide, sodium carbonate, potassium hydroxide and/or potassium carbonate.

An alternative, likewise preferred embodiment of the process uses the base in the form of a powder having an average particle size of 0.1 μm to 2000 μm. Particular preference in this case is given to using powderous sodium carbonate, sodium hydrogencarbonate, potassium carbonate and/or potassium hydrogencarbonate.

Step b) is carried out preferably at temperatures between 5° C. and 70° C. and under pressures between 10 and 6000 mbar.

Step b) may entail further optional separative operations, preferably a distillation for the removal of unreacted alcohol from step a).

In step c) of the process of the invention, the reaction product formed from the hydrogen chloride of step a) and the base of step b), i.e. the salt CatClₙ, is converted at least partly into a solid form. This operation may preferably be supported by means of appropriate measures, preferably by the lowering of the temperature and/or by the addition of a solvent in which the salt is insoluble. Typically, however, the salt undergoes spontaneous sedimentation, i.e. sedimentation in solid form without any further measure, when the base of step b) is brought into contact with the reaction mixture from step a).

Step c) is carried out preferably at temperatures between 5° C. and 70° C. and under pressures between 10 and 6000 mbar.

One preferred embodiment of the process is to carry out steps b) and c) at least partly simultaneously.

In step d) of the process of the invention, the solid is removed from the reaction mixture from step, c). For this purpose, preferably, this reaction mixture is separated by a conventional method into a fraction containing predominantly solid and a fraction containing predominantly liquid, more, preferably by filtering or centrifuging. The solid residue is preferably washed one or more times in order to allow isolation of adhering product residues. A suitable washing liquid is any solvent which does not dissolve the salt CatClₙ.

The liquid fractions obtained in step d) contain the product, and are combined. They may also contain unreacted alcohol and water, and possibly solvents or dispersion media, and are worked up to pure tetraalkyl bisphosphate by the methods described in the prior art, preferably by distillation, extraction, filtration, clarification and/or by drying with a drying agent.

The process of the invention is used preferably for preparing fully or partly water-soluble tetraalkyl bisphosphates.

Any one of the four steps of the process can be carried out discontinuously or continuously. The overall process may consist of any desired combinations of steps carried out continuously or discontinuously.

The process of the invention allows the synthesis of tetraalkyl bisphosphates in a better yield than by the processes of the prior art and in a high purity. It differs from the known processes essentially in that no water phase is removed in the course of work-up, such removal leading, particularly in the case of water-soluble tetraalkyl bisphosphates, to yield losses. It is surprising that the removal of the saltlike by-products is so complete that the end product has only a very low salt content. A low salt content in the sense of the present invention means that the concentration of metal ions, which arises from the salt content, in the end product is less than 5000 ppm per metal ion.

The examples below are used to elucidate the invention in more detail, without any intention that they should restrict the invention. The parts referred to are by weight.

For clarification it is noted that the scope of the present invention encompasses all parameters and definitions set out above, given generally or stated in ranges of preference, and in any desired combinations.

### EXAMPLES

### Example 1

### Preparation of Diethylene Glycol Bis(Dichlorophosphate) (not Inventive)

A 1000 ml four-necked flask with stirrer, thermometer, dropping funnel with pressure compensation and reflux condenser was charged with 984.3 g of phosphoryl chloride at 20° C. Then a vacuum of approximately 670 mbar was applied and 332.3 g of diethylene glycol were added dropwise over the course of 4 hours. Cooling in an ice-water bath kept the temperature at 20° C. A clear, colourless reaction mixture was formed. After the end of the metered addition, the pressure was lowered to about 6 mbar, and stirring was continued at 25° C. for 16 hours. This left 1055.7 g (98%) of diethylene glycol bis(dichlorophosphate).

### Example 2

### Preparation of Tetraethyldiethylene Glycol Bisphosphate (not Inventive)

A 1000 ml 4-necked flask was charged under N₂ with 105.8 g of ethanol and 178.9 g of pyridine at 15° C. At this temperature, over the course of 75 minutes, 169.8 g of diethylene glycol bis(dichlorophosphate) from Example 1 were added dropwise. The reaction mixture showed an exothermic reaction and also a white precipitation of pyridine hydrochloride. Ice-water bath cooling was used to maintain the temperature at 15° C. to 20° C. The white suspension was stirred at 15° C. to 20° C. for 4 hours and left to stand at 23° C. for 16 hours. The suspension was then cooled to 0° C., stirred for 60 minutes and filtered with suction. The white salt residue was pressed thoroughly, washed with ethanol and then discarded. The colourless product solution was concentrated under reduced pressure on a rotary evaporator. The resulting white suspension was filtered with suction, and the salt paste was washed with a little acetone, pressed thoroughly and discarded. The colourless liquid obtained was admixed with 200 ml of water and concentrated under reduced pressure on a rotary evaporator. In the course of this concentration procedure, a white crystal coating of sublimed pyridine hydrochloride was formed on the upper third of the distillation still and in the front part of the distillation bridge.

| | |
|---|---|
| Yield | 170.3 g (90%) pale reddish, clear liquid |
| Acid number | 17.15 mg KOH/g |

### Example 3

### Preparation of Tetraethyldiethylene Glycol Bisphosphate (Inventive)

A 1000 ml four-necked flask with stirrer, thermometer, dropping funnel with pressure compensation and reflux condenser was charged under a nitrogen atmosphere with 350 ml of ethanol at 20° C. At this temperature, 169.8 g of diethylene glycol bis(dichlorophosphate) from Example 1 were added dropwise over the course of 30 minutes. Dry ice pellets were dropped in to keep the temperature at 10° C. The colourless solution was subsequently stirred at 15° C. for 4 hours. The colourless and clear synthesis solution was then introduced over the course of 30 minutes to 106 g of sodium carbonate. Cooling in an ice-water bath kept the temperature at 20° C. After 16 hours, the evolution of gas had ended. The white suspension was filtered with suction on a Büchner funnel. The white salt residue was washed with ethanol and discarded. The combined product solutions were concentrated under reduced pressure on a rotary evaporator. In order to clarify the product, it was again filtered with suction on a Büchner funnel.

| | |
|---|---|
| Yield | 183.5 g (97%) colourless liquid |
| Acid number | <0.1 mg KOH/g |
| Sodium content | 4960 ppm |

### Example 4

### Preparation of Tetraethyldiethylene Glycol Bisphosphate (Inventive)

A 1000 ml four-necked flask with stirrer, thermometer, dropping funnel with pressure compensation and reflux condenser was charged under a nitrogen atmosphere with 169.8 g of diethylene glycol bis(dichlorophosphate) from Example 1 at 20° C. At this temperature, 350 ml of ethanol were added dropwise over the course of 30 minutes. Dry ice pellets were dropped in to keep the temperature at 10° C. The colourless solution was subsequently stirred at 15° C. for 4 hours. The colourless and clear synthesis solution was introduced over the course of 30 minutes to 106 g of sodium carbonate. Cooling in an ice-water bath kept the temperature at 20° C. After 16 hours, the evolution of gas had ended. The white suspension was filtered with suction on a Büchner funnel. The white salt residue was washed with ethanol and discarded. The combined product solutions were concentrated on a rotary evaporator. In order to free the product of salt residues, it was again filtered with suction on a Büchner funnel.

| | |
|---|---|
| Yield | 181.8 g (96%) colourless liquid |
| Acid number | <0.1 mg KOH/g |
| Sodium content | 4265 ppm |

### Example 5

### Preparation of Tetraethyldiethylene Glycol Bisphosphate (Inventive)

A 1000 ml four-necked flask with stirrer, thermometer, dropping funnel with pressure compensation and reflux condenser was charged under a nitrogen atmosphere at 20° C. with 350 ml of ethanol. At this temperature, over the course of 125 minutes, 169.8 g of diethylene glycol bis(dichlorophosphate) from Example 1 were added dropwise. Cooling in an ice-water bath maintained the temperature at 10° C. The colourless solution was subsequently stirred at 15° C. for 3 hours. Then 153 g of a 50% strength aqueous sodium hydroxide solution were added dropwise over the course of 30 minutes into the colourless and clear synthesis solution. Cooling in an ice-water bath kept the temperature at 20° C. The white suspension was filtered with suction on a Büchner funnel. The white salt residue was washed with ethanol and discarded. The combined product solutions were concentrated on a rotary evaporator and the residue which remained in the process was filtered on a folded filter.

| | |
|---|---|
| Yield | 182.3 g (96%) colourless liquid |
| Acid number | 0.12 mg KOH/g |
| Sodium content | 4270 ppm |

### Example 6

### Preparation of Tetraethyldiethylene Glycol Bisphosphate (Inventive)

A 1000 ml four-necked flask with stirrer, thermometer, dropping funnel with pressure compensation, and reflux condenser was charged under a nitrogen atmosphere at 20° C. with 350 ml of ethanol. At this temperature, over the course of 125 minutes, 169.8 g of diethylene glycol bis(dichlorophosphate) from Example 1 were added dropwise. Cooling in an ice-water bath kept the temperature at 10° C. The colourless solution was stirred at 15° C. for 3 hours. The colourless and clear synthesis solution was then admixed dropwise over the course of 30 minutes with 153 g of a 50% strength aqueous sodium hydroxide solution. The temperature was maintained at 20° C. by cooling in an ice-water bath. The white suspension was filtered with suction on a Büchner funnel. The white salt residue was washed with ethanol and discarded. The combined product solutions were concentrated on a rotary evaporator. The turbid residue was dissolved in 80 ml of water and extracted with 110 ml of dichloromethane. The extract was concentrated under reduced pressure on a rotary evaporator, and the residue obtained was filtered to remove a little solid.

| | |
|---|---|
| Yield | 170.3 g (90%) colourless liquid |
| Acid number | <0.1 mg KOH/g |
| Sodium content | 605 ppm |

### Example 7

### Preparation of Tetramethyldiethylene Glycol Bisphosphate (Inventive)

The process indicated in Example 2 was used to prepare tetramethyldiethylene glycol bisphosphate from 250 ml of methanol and 169.8 g of diethylene glycol bis(dichlorophosphate) from Example 1.

| | |
|---|---|
| Yield | 140.2 g (87%) colourless liquid |
| Acid number | <0.1 mg KOH/g |
| Sodium content | 4630 ppm |

### Example 8

### Preparation of Tetra-n-Butyldiethylene Glycol Bisphosphate (Inventive)

The process indicated in Example 4 was used to prepare tetra-n-butyldiethylene glycol bisphosphate from 550 ml of n-butanol and 169.8 g of diethylene glycol bis(dichlorophosphate) from Example 1.

| | |
|---|---|
| Yield | 225.7 g (92%) colourless liquid |
| Acid number | <0.1 mg KOH/g |
| Sodium content | 3955 ppm |

### Example 9

### Preparation of 1,4-Butanediol Bis(Dichlorophosphate) (not Inventive)

A 500 ml four-necked flask with stirrer, thermometer, dropping funnel with pressure compensation and reflux condenser was charged with 300.0 g of phosphoryl chloride at 20° C. Then a vacuum of 200 mbar was applied and 45.0 g of 1,4-butanediol were added dropwise over the course of 45 minutes. Cooling in an ice-water bath kept the temperature at 20° C. A clear, colourless reaction mixture was formed. After the end of the metered addition, the pressure was lowered to about 100 mbar, and stirring was continued for 2 hours. A distillation bridge was then mounted on, and the excess of phosphoryl chloride was removed by distillation. This left 144.9 g (91%) of 1,4-butanediol bis(dichlorophosphate).

### Example 10

### Preparation of Tetraethyl-1,4-Butanediol Bisphosphate (Inventive)

The process indicated in Example 4 was used to prepare tetraethyl-1,4-butanediol bisphosphate from 350 ml of ethanol and 161.6 g of 1,4-butanediol bis(dichlorophosphate) from Example 9.

| | |
|---|---|
| Yield | 158.3 g (87%) colourless liquid |
| Acid number | 0.3 mg KOH/g |
| Sodium content | 4085 ppm |

### Example 11

### Solubility of Tetraalkyl Bisphosphates in Water (Inventive)

A separating funnel was charged with 50.0 g of tetraalkyl bisphosphate and 50.0 g of fully demineralized water, and was shaken vigorously and then left to stand for 1 hour. If phase separation became apparent, the lower, aqueous phase was carefully separated off and weighed (m_{W}). The aqueous phase was concentrated to constant weight under reduced pressure on a rotary evaporator, and the residue was likewise weighed (m_{R}). The variable m_{R}/m_{W}×100% was calculated, as a measure of the solubility in water, and has been listed in Table 1.

With the substances tetramethyldiethylene glycol bisphosphate and tetraethyldiethylene glycol bisphosphate, there was no phase separation in the experiment described above. Further experiments with different weight ratios of tetraalkyl bisphosphate and water likewise gave no phase separation for these substances. This means that tetramethyldiethylene glycol bisphosphate and tetraethyldiethylene glycol bisphosphate are fully water-soluble.

TABLE 1
Solubility of tetraalkyl bisphosphates in water

| Tetraalkyl bisphosphate | m_{R}/m_{W} × 100% |
|---|---|
| Tetraethyldiethylene glycol bisphosphate | no phase separation |
| (Examples 3-6) | |
| Tetramethyldiethylene glycol bisphosphate | no phase separation |
| (Example 7) | |
| Tetra-n-butyldiethylene glycol bisphosphate | 3% |
| (Example 8) | |
| Tetraethyl-1,4-butanediol bisphosphate | 26% |
| (Example 10) | |

### EVALUATION

Example 11 shows that the tetraalkyl bisphosphates under consideration are totally or partly miscible with water. These substances, therefore, according to the preparation processes from the prior art, can be prepared only in a poor yield or not at all. Examples 3 to 8 and 10 show that tetraalkyl bisphosphates can be prepared easily and in high yield by the process of the invention. Products of high purity are obtained in this case, as can be gleaned from the low acid numbers and sodium contents. It is surprising that preparation is possible successfully in particular in the case of partly or fully water-soluble tetraalkyl bisphosphates.

Demineralized water in the sense of the present invention is characterized by possessing a conductivity of 0.1 to 10 μs, with the amount of dissolved or undissolved metal ions being not greater than 1 ppm, preferably not greater than 0.5 ppm for Be, Co, Ni, Mo, Cr and Cu as individual components, and not greater than 10 ppm, preferably not greater than 1 ppm, for the stated metals in total.

What is claimed is:

1. A process for preparing a fully water-soluble tetraalkyl bisphosphate, in which
a) a tetrachlorobisphosphate is reacted with one or more alcohols,
b) when in step a) at least 50% of the P—Cl groups present in the tetrachlorobisphosphate have reacted, the reaction mixture from step a) is reacted with a base comprising one or more substances of the formula (Catⁿ⁺)ₐ(X^{m-})_{b}, in which Catⁿ⁺ is a cation with a charge of n, X^{m-} is an anion with a charge of m, and a and b are integers which satisfy the condition n×a=m×b,
c) then an amount of sufficient water is added to the reaction mixture from step b) sufficient to form a mixture consisting of two separate, liquid phases, and
d) the phase comprising the tetraalkyl bisphosphate is isolated from the mixture obtained in step c).

2. The process of claim 1, in which the tetrachlorobisphosphate is a substance of the general formula (I) 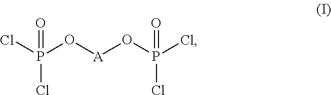
in which
A is a straight-chain, branched and/or cyclic C₄ to C₂₀ alkylene radical, a moiety —CH₂—CH═CH—CH₂—, a moiety —CH₂—C≡C—CH₂—, a moiety —CHR⁵—CHR⁶—(O—CHR⁷—CHR⁸)a- in which a is a number from 1 to 5, a moiety —CHR⁵—CHR⁶—S(O)b-CHR⁷—CHR⁸— in which b is a number from 0 to 2, or a moiety —(CHR⁵—CHR⁶)c-O—R⁹—O—(CHR⁷—CHR⁸)d- in which c and d independently of one another are numbers from 1 to 5,
R⁵, R⁶, R⁷, R⁸ independently of one another are H or methyl,
R⁹ is a moiety —CH₂—CH═CH—CH₂—, a moiety —CH₂—C≡C—CH₂—, a 1,2-phenylene radical, a 1,3-phenylene radical, a 1,4-phenylene radical, a radical of the general formula (II), 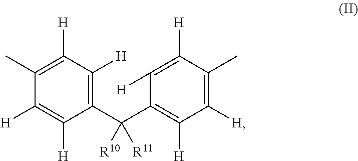
a radical of the general formula (III), 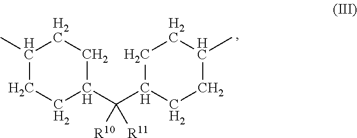
a radical of the general formula (IV), 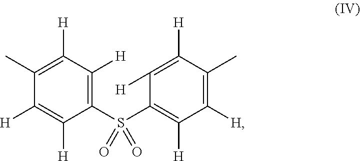
or a radical of the formula —C(═O)—R¹²—C(═O)—,
R¹⁰ and R¹¹ independently of one another are H or C₁ to C₄ alkyl, or R¹⁰ and R¹¹ together form an alkyl-substituted or unsubstituted ring having 4 to 8 C atoms, and
R¹² is a straight-chain, branched and/or cyclic C₂ to C₈ alkylene radical, a 1,2-phenylene radical, a 1,3-phenylene radical, or a 1,4-phenylene radical.

3. The process of claim 2, in which A is a straight-chain C₄ to C₆ alkylene radical, a moiety of the general formula (III) in which R¹⁰ and R¹¹ are identical and are methyl, a moiety of the formula (V), (VI) or (VII), 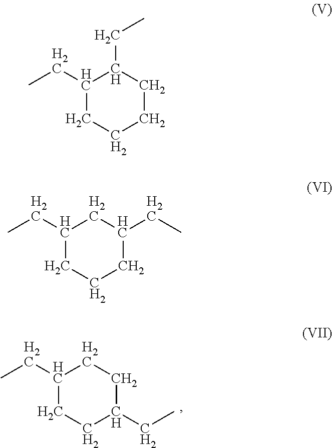
or is a moiety —CHR⁵—CHR⁶—(O—CHR⁷—CHR⁸)ₐ—, or a moiety —(CHR⁵—CHR⁶)_{c}—O—R⁹—O—(CHR⁷—CHR⁸)_{d}— in which a c and d independently of one another are a number from 1 to 2, R⁵, R⁶, R⁷, and R⁸ are identical and are H and R⁹ is a moiety of the general formula (II) in which R¹⁰ and R¹¹ are identical and are methyl.

4. The process of claim 2, in which A is a radical selected from the group consisting of —CH₂CH₂—O—CH₂CH₂—, —CH₂CH₂CH₂CH₂— and —CH₂—CH(CH₂CH₂)₂CH—CH₂—.

5. The process of claim 1, in which the alcohol is selected from the group consisting of methanol, ethanol, 1-propanol, 2-propanol, 2-methyl-1-propanol, 1-butanol and 2-butanol.

6. The process of claim 1, in which the alcohol is selected from the group consisting of methanol and ethanol.

7. The process of claim 1, in which Catⁿ⁺ is a substituted or unsubstituted ammonium ion, an alkali metal ion or an alkaline earth metal ion and X^{m-} is a hydroxide, an alkoxide, an oxide, a carbonate, a hydrogencarbonate, a phosphate, a hydrogenphosphate, a dihydrogenphosphate or an acetate.

8. The process of claim 1, in which the amount of the base is selected such that the reaction mixture after step b) has a pH between 6 and 11.

9. The process of claim 1, in which the base is used in the form of an aqueous solution or dispersion.

10. The process of claim 9, in which use is made of the base as a 10%-60% strength by weight aqueous solution of sodium hydroxide, sodium carbonate, potassium hydroxide or potassium carbonate or a mixture thereof.

11. The process of claim 1, in which the base is used in the form of a powder having an average particle size of 0.1 μm to 2000 μm.

12. The process of claim 11, in which use is made of the base as a powderous sodium carbonate, sodium hydrogencarbonate, potassium carbonate or potassium hydrogencarbonate or a mixture thereof.

13. The process of claim 1, in which one or more of steps a) to e) are carried out discontinuously.

14. The process of claim 1, in which one or more of steps a) to e) are carried out continuously.

15. The process of claim 1 in which the amount of water used in step c) is between 25 and 50 mol, based on one mole of tetrachlorobisphosphate.
